(19) United States
(12) Patent Application Publication
(10) Pub. No.: US 2005/0279226 A1
(43) Pub. Date: Dec. 22, 2005

(54) Nutcracker

(75) Inventors: Gerhard Feldevert, Gronau (DE); Peter Krellner, Olbernhau (DE)

Correspondence Address: JORDAN AND HAMBURG LLP, 122 EAST 42ND STREET, SUITE 4000, NEW YORK, NY, 10168, US

(73) Assignee: KWO Kunstgewerbe-Werkstaetten GmbH, Olbernhau (DE)

(21) Appl. No.: 11/152,992

(22) Filed: Jun. 14, 2005

(30) Foreign Application Priority Data
Jun. 17, 2004 (DE) 20 2004 009514.9

(51) Int. Cl. A23N 5/00

(52) U.S. Cl. 99/468

(57) ABSTRACT

A nutcracker includes a main body which has a recess for receiving a lever, the lever being pivotably mounted in the recess. An operating chamber which is opened or closed through relative movement of the lever in relation to the main body is suitable for receiving nuts, their shells being able to be crushed when the operating chamber is constricted. An arrangement giving a form fit is provided in the operating chamber on the lever. Nuts laid in the arrangement providing the form fit are clamped on more than two points and are broken through pressure and/or thrust load when the lever is moved.

### FIELD OF APPLICATION OF THE INVENTION

The present invention is used in nutcrackers, preferably nutcrackers having an external contour shaped into a figure.

### BACKGROUND INFORMATION

Typical wooden nutcrackers, which are usually modeled, contoured, painted, or sculpted into a model from the region, are generally known in the genre of the folk art of the Erz Mountains.

The above-mentioned nutcrackers are typically manufactured completely from wood. The main body predominantly responsible for the external contour is manufactured in one material from a massive piece of wood in a typical embodiment. A recess is incorporated centrally in this case, which later receives the nutcracker lever. As required by the manufacturing, firstly a wood part is externally contoured and subsequently the recess for the lever is incorporated using suitable manufacturing methods into the preprocessed main body. In accordance with the typical design of such nutcracker figures, because of the construction cited, a constriction must be implemented in the transition region between upper body and head. However, the top of the operating chamber also lies in this plane, so that this cross-sectional constriction is simultaneously responsible for the maximum load capacity of the main body. Monolithically manufactured main bodies of this type often break at this point.

A further embodiment of the manufacturing method is that first only the main body is manufactured monolithically, the recess required for the lever is incorporated after the processing of the external contour, and a separately manufactured head is subsequently placed on the main body. In this case, the preferred types of attachment are butted gluing or the introduction of dowel holes and subsequent manufacturing of a glued dowel connection. The first is not suitable for allowing breaking of nuts using nutcrackers implemented in this way. Even if dowel connections are implemented, these may break and the head of the figure may detach from the main body. The dowel connections, which were originally designed for thrust strain, are loaded in tension in nutcrackers. The highest load of the connections is therefore solely determined by the quality of the gluing.

Furthermore, requirements in regard to the design of the lever shape result through the design of the nutcracker figures. In general, an angled lever is implemented, which is mounted in a hole in the main body. Since the nutcracker mouth must be closed when not in use, in the majority of implemented figures, a fleece trimming is additionally attached the front of the nutcracker lever, so that its shape is largely predefined. The rear view is also to be closed for design reasons. The contour of the top of the nutcracker lever usually resulting in this case is arched slightly concave, the radius to the tooth front continuously becoming smaller, while it is implemented as very flat, almost linear in the rear region. This shape has the disadvantage that the opening of the nutcracker mouth is approximately wedge-shaped when actuating the lever, due to which nuts may be laid only in the front part of the nutcracker mouth. The distance between the support points of the nuts and the plane of the pivot axis of the lever is large in this case, through which large actuating forces are necessary and, in addition, the load of the connection point between the body and head is correspondingly large. Reducing the actuating forces by lengthening the nutcracker lever is only possible in a restricted way.

According to a suggestion in DE 296 18 171 U1, a solution of this problem is that a nutcracker lever is used which has a deep trough on the top of the short leg, which may receive the nut nearly completely, while a buttress is implemented on the bottom of the short lever, so that during the cracking procedure, a relative motion to the main body results on the bottom of the short leg in particular, which requires additional force to be expended due to surface roughness. A smoothing effect of the wood surfaces in contact is also disadvantageous in this case, through which the recess in the main body is enlarged, while the thickness of the short leg of the lever is reduced. The deep trough weakens the cross-section of the lever. In the unused state, such a lever is not fixed, which must be seen as the most significant disadvantage of a solution.

### OBJECT OF THE INVENTION

It is therefore the object of the present invention to suggest an arrangement for nutcrackers manufactured from wood or comparable materials having a model-type external design, which may be implemented without significant further outlay in relation to known arrangements, does not restrict the design possibilities, and simultaneously increases the reliability when cracking nuts, and reduces overloads and actuating forces or keeps them at a lower level.

### SUBJECT MATTER OF THE INVENTION

The subject matter of the present invention results from the features of the claims, the description, and the exemplary embodiments. Exemplary embodiments and figures reproduce embodiments preferred on the date of application and do not restrict the present invention.

The present invention initially assumes that when cracking nuts using nutcrackers made of wood, which are designed as figures, a significant reduction of the load may be achieved if the current predominantly pressure load of the nuts to be cracked has a thrust load superimposed on it. Furthermore, it is based on the recognition that a nutshell destroyed solely by pressure load loses any support forces in the moment of bursting and the seed located inside is usually also damaged at the same time. Furthermore, the present invention is based on the recognition that, at least in the case of the typically implemented dowel connection, a thrust strain thereof is closer to the original intended purpose than the currently predominant axial strain. A further recognition is that a multipoint support of the nut increases the probability of success of cracking the nutshell in relation to the two-point support practiced until now.

The means according to the present invention are therefore optimizing the lever ratios, the operating chamber, and, resulting therefrom, optimizing the movement sequences, using appropriately shaped recesses for the nut, and using sufficiently solid connections between the main body of the nutcracker and its head.

According to the present invention, an angled lever is laid in a recess in the main body of the nutcracker and held there by an axis. The angled lever has a short leg, which is frequently provided with a fleece trimming on its front end, as is known, and whose front edge forms the tooth image of the nutcracker. The short leg has a significantly enlarged cross-section in relation to the long leg, which is used for actuation. The top of the short lever is implemented as concave, a smaller radius of curvature being implemented in the active region. The position of the curve is selected so that the largest depth is reached before the plane of the axis.

If the nutcracker lever is raised at the long end, the nutcracker mouth thus opens correspondingly wide and it is easily possible to lay a nut therein.

The nutcracker lever has a depression in the region of the radius of curvature, whose shape is selected so that it may receive and fix the nuts laid therein. It is also possible to incorporate a similar depression in the bottom of the head and/or in the upper delimitation of the recess. It is sufficient in this case if one of the components has such a depression.

However, it is especially advantageous to position depressions in both components, the positioning being selected in such a way that the central axes of the depressions are positioned laterally offset to one another.

If a nut to be cracked is laid in such a nutcracker mouth, it initially lies on the curvature of the angled lever, and is laid in a depression present therein. When the lever is pressed down, the nut is supported on the bottom of the head and/or the upper delimitation of the recess and a tension is built up in the nutshell. Since there is at least one depression, the nut is simultaneously secured in position, so that as the lever is pressed down further and the nutcracker mouth is thus constricted, a pressure load arises and simultaneously a lateral thrust exists. The overall tension which thus built up causes the bursting of the nutshell.

The components participating in the procedure described above are dimensioned in such a way that only small relative movements arise and an axial movement of the nutcracker mouth, as in currently known nutcrackers, with simultaneous destruction of the seed, is largely avoided. This is achieved through a lateral movement which predominates even after bursting of the nutshell, through which only a minimum constriction of the operating chamber arises.

The lever is mounted so that the bearing point is implemented in the highest possible position and simultaneously with the maximum possible displacement in the direction toward the nutcracker mouth. The actual position is to be found through optimization while considering the geometric ratios, the possible dimensions of nuts to be cracked, and the dimensions of the nutcracker body.

In the generally preferred embodiment of the nutcracker having depressions on both sides and an optimized position of the axis, the axial movement of the short leg of the lever remains small, while, due to the predominantly angled movement in connection with the fixing of the nut in the depressions, a displacement of the nut body occurs that is not possible due to the fixing in the depressions and therefore the tension required for destroying the shell is built up.

A further preferred embodiment uses additional components made of hard materials inlaid into the depressions, which avoid overload of the wood material of the lever and/or of the other components. The corresponding inlays may be attached in the depressions through form fitting, friction locking, or material bonding. In this case, attachment with the aid of a screw has proven itself.

The inlays are preferably to have a conical shape, so that they are partially adapted to the external shape of the nut, but simultaneously only allow point contact and therefore the introduction of larger forces into the shell via these points. A further embodiment of the inlays may comprise profiling them.

The effects described above may also be achieved if the depressions are dispensed with and components which allow the required form fit in relation to the nut to be cracked through corresponding shaping are used in their place. Furthermore, the effect described may be achieved through the use of multiple components, such as pins, which produce the form fit.

If a later connection is implemented between the main body and a head placed thereon, the typical dowel connection may be used, which is loaded through thrust strains according to the present invention here, in addition to having axially reduced load. However, a preferred form of the present invention comprises implementing a form-fitting connection between head and main body by using wood screws. Because of their design, these are also capable of securely transferring and dissipating the axial strains arising during cracking of nuts.

### EXEMPLARY EMBODIMENTS

The present invention will be explained in greater detail in the following on the basis of an exemplary embodiment.

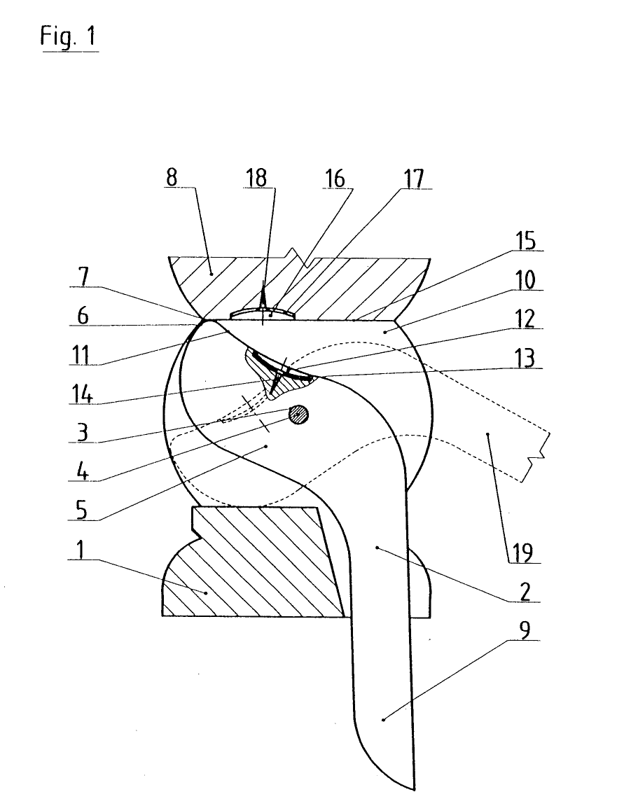

FIG. 1 shows a partial sectional illustration through a nutcracker body having the lever arrangement and

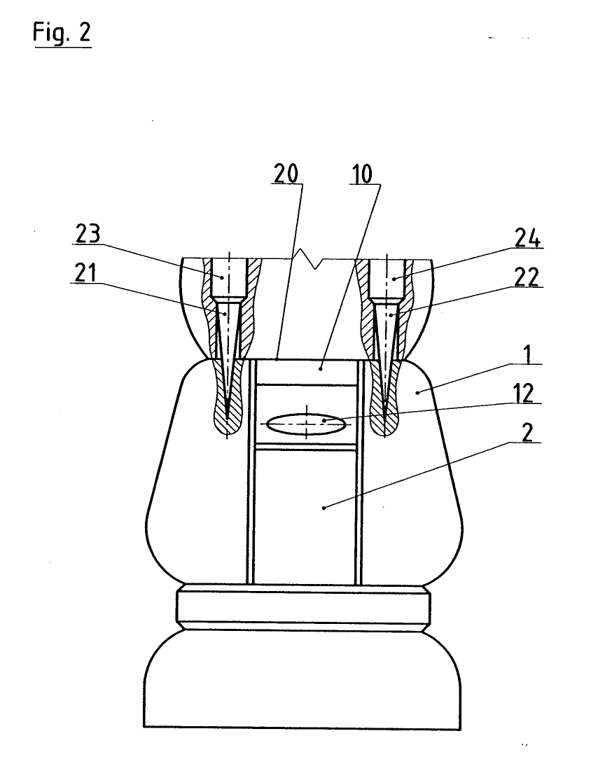

FIG. 2 shows a partially cutaway illustration of a nutcracker body in a front view.

A main body (1) is combined with a lever (2), the lever (2) being pivotably attached in the hole (3) with the aid of the axis (4) on the main body (1). The lever (2) is arched on its short leg (5) and forms a front edge (6) which, in combination with the front edge (7) of the head (8), forms the strip of teeth typical in nutcrackers. The long leg (9) of the lever (2) is approximately vertical in the starting position of the lever (2) and may fill up a recess (10) in the main body (1).

The top (11) of the short leg (5) is shaped concavely with a small radius starting from the front edge (6) and then passes into a convexly curved shape, which is not functionally necessary, however, and may be selected solely from design aspects. In order to allow a small positive amount in front of the plane of the axis (4), a depression (12) is embedded into the top (11) of the short leg (5), which receives a spherical component (13), that is attached by a screw (14).

A depression (16) is embedded on the bottom (15) of the head (8), approximately at the level of the axis (4), into which a spherical component (17) is also embedded and attached by a screw (18).

If the lever (2) is brought into the position (19), a nut may be laid in the depression (12). As the lever (2) is subsequently pressed down in the direction toward its starting position, the nut laid therein experiences a movement on a circular path until it rests against the bottom edge (20) of the head (8) and particularly reaches the rigid depression (16) present therein. If the lever (2) is then pressed even further down and the circular movement is continued further, the nut may no longer execute a movement, the shell thereof reaches a strain state and breaks upon exceeding the breaking strain. If the lever (2) has reached its end position again after destroying the shell, the depression (12) in the lever (2) lies approximately in the plane of the axis (4) and/or the depression (16). Depending on the dimensioning, the position may also be behind the plane of the axis (4) and/or the depression (16).

When the lever (2) is actuated, there is no pronounced axial movement of the top (11) of the short leg (5) against the bottom (15) of the head (8), due to the circular movement, because of which the seed of a broken nut is axially deformed only to a limited extent.

The head (8) of the arrangement is permanently connected to the main body (1) by the screws (21) and (22). These are screwed into the stepped holes (23) and (24) and are held in the main body (1) by their profiled shafts. Therefore, a form-fitting connection between head (8) and main body (1) is manufactured, which withstands the mechanical loads arising during cracking of nuts. The small shaft diameter of the screws (21) and (22) also allows the contact region between head (8) and main body (1) to be designed more strongly in accordance with aesthetic aspects than previously.

1. A nutcracker comprising, a main body which has a recess for receiving a lever, said lever being pivotably mounted in the recess, an operating chamber opened or closed through relative movement of the lever in relation to the main body, the operating chamber being suitable for receiving nuts, and their shells being able to be crushed when the operating chamber is constricted, an arrangement giving a form fit provided in the operating chamber on its upper delimitation and/or on its lower delimitation, on the a short leg of the lever, nuts laid in the arrangements providing the form fit are clamped on more than two points and are broken through pressure and/or thrust load when the lever is moved.

2. The nutcracker according to claim 1,
wherein the arrangement providing the form fit are implemented through a depression and/or protrusion having at least one concave arch and/or by multiple elements providing a form fit.

3. The nutcracker according to claim 1,
wherein the pivot axis of the lever is positioned near the top of the short leg thereof.

4. The nutcracker according to claim 1, wherein the arrangement providing the form fit, which lies in the upper delimitation of the operating chamber, has its central axis in or in front of the plane of the pivot axis.

5. The nutcracker according to claim 1, wherein the arrangement providing the form fit is positioned in the lever and its central axis is at a slight distance in front of the pivot axis of the lever.

6. The nutcracker according to claim 1, wherein the arrangement providing the form fit, which lies in the lever, executes a rotational movement with an axial movement superimposed thereon in relation to the arrangement providing the form fit lying in the upper delimitation.

7. The nutcracker according to claim 1, wherein the arrangement providing the form fit is implemented as depressions and are filled up by inlays.

8. The nutcracker according to claim 7 wherein the inlays are implemented as spherical, arched, profiled, or provided with a profiled surface.

9. The nutcracker according to claim 7, wherein the inlays are fixed by friction locking and/or form fitting and/or material bonding.

10. The nutcracker according to claim 1, wherein the connection between the main body and a component forming the upper terminus of the operating chamber is secured by elements providing a form fit.

11. The nutcracker according to claim 10, wherein the component forming the upper terminus of the operating chamber is secured by screws.

12. The nutcracker according to claim 7, wherein said inlays are wear-proof inlays.

13. The nutcracker according to claim 7, wherein said inlays are metal inlays.

14. The nutcracker according to claim 1, wherein the arrangement giving a form fit provided in the operating chamber on its upper delimitation and/or on its lower delimitation is on the top of a short leg of the lever.
